(19) United States
(12) Patent Application Publication
(10) Pub. No.: US 2018/0370322 A1
(43) Pub. Date: Dec. 27, 2018

(54) FRONT COMPARTMENT PACKAGING OF AUTOMOTIVE HVAC MODULE

(71) Applicant: NIO USA, Inc., San Jose, CA (US)

(72) Inventors: Matthew S. Filipkowski, Pleasanton, CA (US); Jochen Paesen, Munich (DE); Adam K. Phillips, Munich (DE)

(21) Appl. No.: 15/630,291

(22) Filed: Jun. 22, 2017

(51) Int. Cl. B60H 1/00

(52) U.S. Cl. CPC B60H 1/00028; B60H 2001/00214; B60H 1/0055

(57) ABSTRACT

An HVAC module is mounted in a front compartment of a vehicle, proximate a wall that separates the front compartment of the vehicle from a passenger cabin of the vehicle. The HVAC module includes an intake and blower section that receives air from the passenger cabin or from outside the vehicle and provides it to a conditioning and distribution section of the HVAC module, which selectively conditions the air with heating or cooling equipment and distributes the conditioned air to the passenger cabin.

### FIELD

The present disclosure is generally directed to vehicle systems, and more particularly to vehicle heating, ventilation, and cooling systems.

### BACKGROUND

Heating, ventilation, and cooling (“HVAC”) systems have long been included in automobiles, whether as standard or optional equipment. Such systems typically comprise an HVAC module, which receives air, conditions the air as necessary (whether by heating or cooling, although in some instances no conditioning is needed or effected), mixes the air as necessary (e.g., mixes cooled air with fresh air or warm air with fresh air to achieve a desired air temperature), and blows the air through one or more ducts to one or more vents in the passenger cabin of the vehicle. HVAC modules thus selectively provide air, for example, to dashboard-mounted or dash-level vents, ceiling and sidewall mounted vents, floor-mounted or foot-level vents, and defrosting vents. The operation of typical HVAC modules is described in U.S. Pat. No. 4,852,638, which is incorporated by reference herein in its entirety.

Several prior art references disclose that some portions of an HVAC system, including one or more, but not all, of the components of an HVAC module, may be located in a compartment forward of the passenger cabin. These references include U.S. Patent Application Publication No. 2003/0107241, entitled “Motor Vehicle Front End Structure”; U.S. Pat. No. 5,305,613, entitled “Air Conditioning System Suitable for Use in a Electric Vehicle,” and a document entitled Porsche 944 HVAC Operation and Malfunctions. Each of these references is incorporated by reference herein in its entirety.

### BRIEF DESCRIPTION OF THE DRAWINGS

FIG. 1 shows a vehicle in accordance with embodiments of the present disclosure;

FIG. 2 shows a passenger compartment of a vehicle such as the vehicle shown in FIG. 1 in accordance with embodiments of the present disclosure;

FIG. 3 shows an HVAC module mounted in a front compartment of a vehicle in accordance with embodiments of the present disclosure;

FIG. 4 shows an HVAC module in accordance with embodiments of the present disclosure; and

FIG. 5 shows an HVAC module mounted in a front compartment of a vehicle in accordance with embodiments of the present disclosure.

### DETAILED DESCRIPTION

Embodiments of the present disclosure will be described in connection with a vehicle, and more particularly with respect to an automobile. However, for the avoidance of doubt, the present disclosure encompasses the use of the aspects described herein in vehicles other than automobiles.

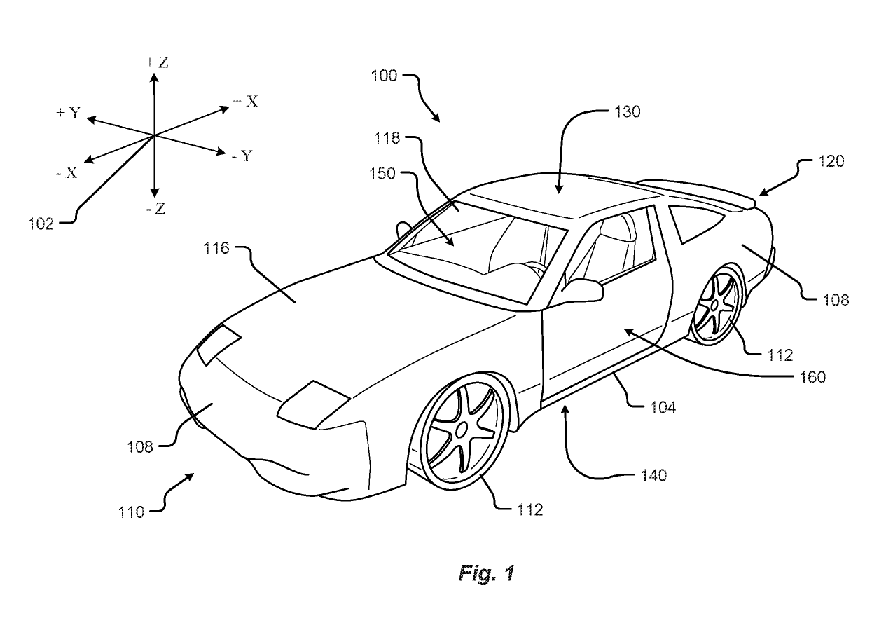

FIG. 1 shows a perspective view of a vehicle 100 in accordance with embodiments of the present disclosure. The vehicle 100 comprises a vehicle front 110, vehicle aft 120, vehicle roof 130, at least one vehicle side 160, a vehicle undercarriage 140, and a vehicle interior 150. The vehicle 100 may include a frame 104, one or more body panels 108 mounted or affixed thereto, and a windshield 118. The vehicle 100 may include one or more interior components (e.g., components inside an interior space 150, or user space, of a vehicle 100, etc.), exterior components (e.g., components outside of the interior space 150, or user space, of a vehicle 100, etc.), drive systems, controls systems, structural components, etc.

Coordinate system 102 is provided for added clarity in referencing relative locations in the vehicle 100. In this detailed description, an object is forward of another object or component if the object is located in the −X direction relative to the other object or component. Conversely, an object is rearward of another object or component if the object is located in the +X direction relative to the other object or component.

The vehicle 100 may be, by way of example only, an electric vehicle or a gas-powered vehicle. Where the vehicle 100 is an electric vehicle, the vehicle 100 may comprise one or more electric motors powered by electricity from an on-board battery pack. The electric motors may, for example, be mounted near or adjacent an axis or axle of each wheel 112 of the vehicle, and the battery pack may be mounted on the vehicle undercarriage 140. In such embodiments, the front compartment of the vehicle, referring to the space located under the vehicle hood 116, may be a storage or trunk space. Where the vehicle 100 is a gas-powered vehicle, the vehicle 100 may comprise a gas-powered engine and associated components in the front compartment (under the vehicle hood 116), which engine may be configured to drive either or both of the front wheels 112 and the rear wheels 112. In some embodiments where the vehicle 100 is gas-powered, the gas-powered engine and associated components may be located in a rear compartment of the vehicle 100, leaving the front compartment available for storage or trunk space or for other uses. In some embodiments, the vehicle 100 may be, in addition to a battery-powered electric vehicle and a gas-powered vehicle, a hybrid electric vehicle, a diesel-powered vehicle, or a fuel cell vehicle.

Although shown in the form of a car, it should be appreciated that the vehicle 100 described herein may include any conveyance or model of a conveyance, where the conveyance was designed for the purpose of moving one or more tangible objects, such as people, animals, cargo, and the like. The term “vehicle” does not require that a conveyance moves or is capable of movement. Typical vehicles may include but are in no way limited to cars, trucks, motorcycles, buses, automobiles, trains, railed conveyances, boats, ships, marine conveyances, submarine conveyances, airplanes, space craft, flying machines, human-powered conveyances, and the like.

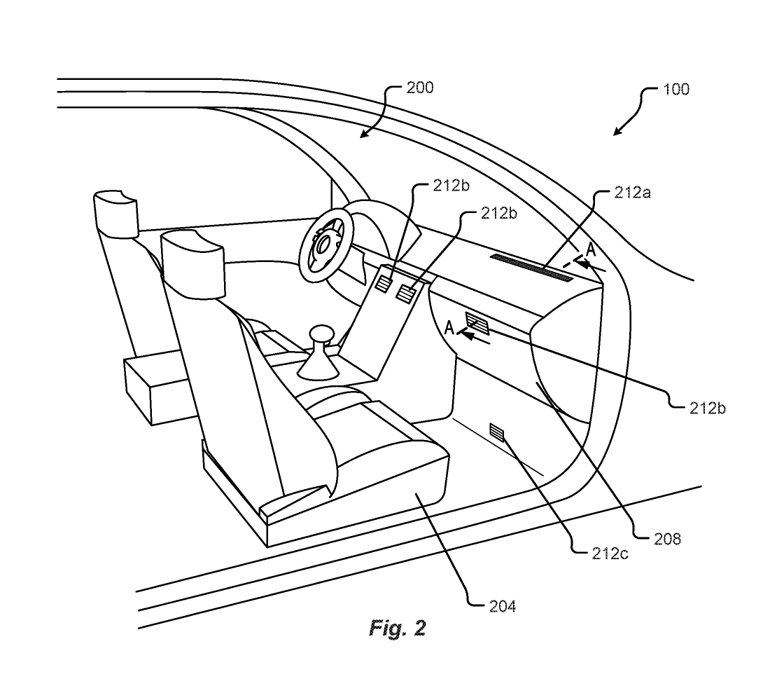

Referring now to FIG. 2, a vehicle passenger cabin 200 of a vehicle 100 according to embodiments of the present disclosure includes a passenger seat 204, and a dashboard or instrument panel or dash panel (all of which terms may be used interchangeably herein) 208. The dashboard may include one or more air registers or vents 212a, 212b, and 212c, through which heated, cooled, or unconditioned air may be introduced into the passenger compartment for climate control and ventilation purposes. The air vents 212a, 212b, and 212c cover apertures in one or more air ducts (not shown in FIG. 2) that channel fresh or recirculated air to or from an HVAC module (not shown in FIG. 2) of the vehicle 100, as appropriate, and to the air vents 212a, 212b, and 212c for introduction into the passenger cabin 200. One or more of the air vents may be positioned adjacent a windshield of the vehicle 100 for defrost purposes, as is the air vent 212a in FIG. 2. Others of the air vents may be positioned in the dashboard 208, for supplying air to the passenger cabin 200 at or near the head and/or torso of the occupants of the passenger cabin 200, as are the air vents 212b in FIG. 2. Still others of the air vents may be positioned at or near the floor of the passenger cabin 200, for supplying air to the passenger cabin 200 at or near the feet of the occupants of the passenger cabin 200, as is the air vent 212c. Any number of defrost air vents 212a, dash-level air vents 212b, and foot-level air vents 212c may be included in the passenger cabin 200. In some embodiments, air vents may be positioned at or near the sides of the dashboard 208 for defrosting one or more side windows of the vehicle 100; and in or near the ceiling of the vehicle 100 for discharging air onto occupants of the vehicle 100 from above. In some embodiments, a vehicle such as the vehicle 100 may have a plurality of rows of seats, and air vents may be positioned immediately in front of or in close proximity to each row of seats so as to supply air to the occupant(s) of each of the rows of seats.

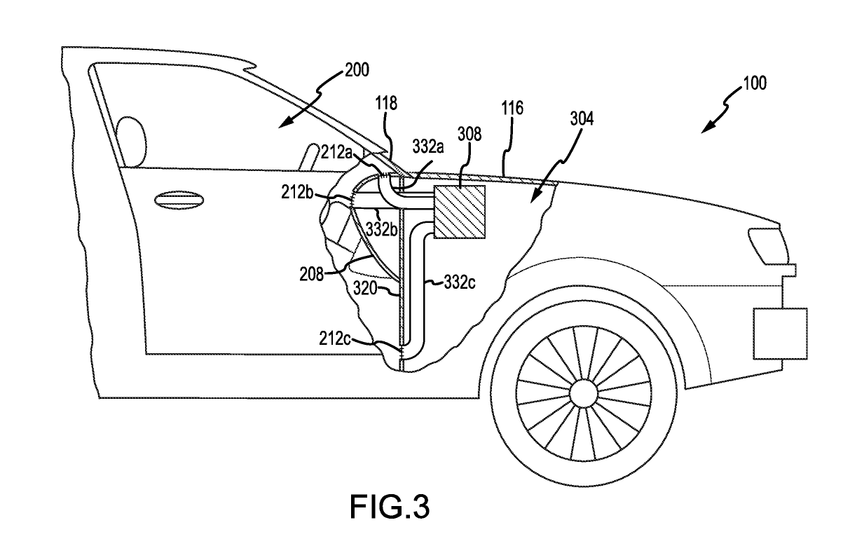

Referring now to FIG. 3, a vehicle 100 is shown with a cutaway portion showing a sectional view (taken at roughly Line A-A of FIG. 2) of the structure between the passenger cabin 200 and a front compartment 304. The vehicle front compartment 304 may be, as described above with respect to FIG. 1 and by way of example only, a trunk or storage space in some embodiments, particularly but not exclusively when the vehicle in question utilizes electric propulsion (as shown here) or where a gas-powered engine is mounted in the rear of the vehicle, or an engine compartment in other embodiments. The vehicle front compartment 304 may not be climate controlled. In some embodiments, the vehicle front compartment 304 may be separate and apart from the passenger compartment. Cross-sections of portions of the windshield 118 and the hood 116 are visible in FIG. 3.

Air ducts 332a, 332b, and 332c channel air from an HVAC module 308 to the air vents 212a, 212b, and 212c, respectively. The air ducts 332a, 332b, and 332c may be mounted forward of the dash wall 320, rearward of the dash wall 320, or partially forward and partially rearward of the dash wall 320. For example, although the air duct 332c is shown as forward of the dash wall 320 in FIG. 3, the air duct 332c may also be configured to pass through the dash wall 320 near the HVAC module 308, and to then run downward to the air vent 212c (which may be mounted rearward of the dash wall 320 rather than in the dash wall 320). The HVAC module 308 may be mounted to the dash wall 320 of the vehicle 100, within the front compartment 304. The dash wall 320 is positioned forward of the passenger cabin 200 of the vehicle 100, and in some embodiments separates the passenger cabin 200 (including the dash panel 208 and the space between the dash panel 208 and the dash wall 320) from the front compartment 304. Among other things, disposing the HVAC module 308 in a separate compartment (e.g., the vehicle front compartment 304) from the passenger cabin 200 provides additional space in the vehicle interior 150 and/or the passenger cabin 200. HVAC modules are typically installed in the space beneath an automotive instrument panel, which requires the instrument panel to occupy space that could otherwise be used for another purpose. Placement of the HVAC module 308 within the front compartment 304, outside of the passenger cabin 200, increases the amount of available space in the passenger cabin 200. The space made available by locating the HVAC module 308 within the front compartment 304 may be used, for example, as empty space (e.g., to make the passenger cabin 200 feel roomier), for storage (e.g., for a larger glovebox or for another storage compartment), or for installation of another sub-system or feature (e.g., one or more components of a vehicle infotainment system).

In some embodiments, the HVAC module 308 or portions thereof may be mounted to a structure or element of the vehicle 100 or to a component thereof other than the dash wall 320. For example, the HVAC module 308 may be mounted to the floor and/or to one or more sidewalls of the front compartment 304. The HVAC module 308 may also be mounted to a cross-member of any other available structural component within the front compartment 304.

The dash wall 320 separates the front compartment 304 from the passenger cabin 200. For purposes of this specification, the various components and elements between the dash wall 320 and the dash panel 208 are considered to be within the passenger cabin 200. The dash wall 320 and dash panel 208 may be the same structure, parts of the same structure, or different structures. Additionally, each of the dash wall 320 and the dash panel 208 may comprise a single integral structure or a structure formed of a plurality of assembled or otherwise connected elements.

In some embodiments, placement of the HVAC module 400 in the front compartment 304 allows some or all of the dashboard 208 to be eliminated or significantly reduced in size. For example, the dashboard 208 depicted in front of the passenger seat 204 in FIG. 2 may be eliminated, due in part to movement of the HVAC module 308 to the front compartment 304. In such embodiments, the dash wall 320 may provide the only separation between the passenger cabin 200 and the front compartment 304, and the vent 212b located on the dashboard 208 in front of the passenger seat 204 may be positioned in the dash wall 320. One benefit of such a configuration is the elimination of the need for at least some of the ducting inside the passenger cabin 200 that would otherwise be necessary to channel air from an aperture in the dash wall 320 to the surface of the dashboard 208 immediately in front of the passenger seat 204.

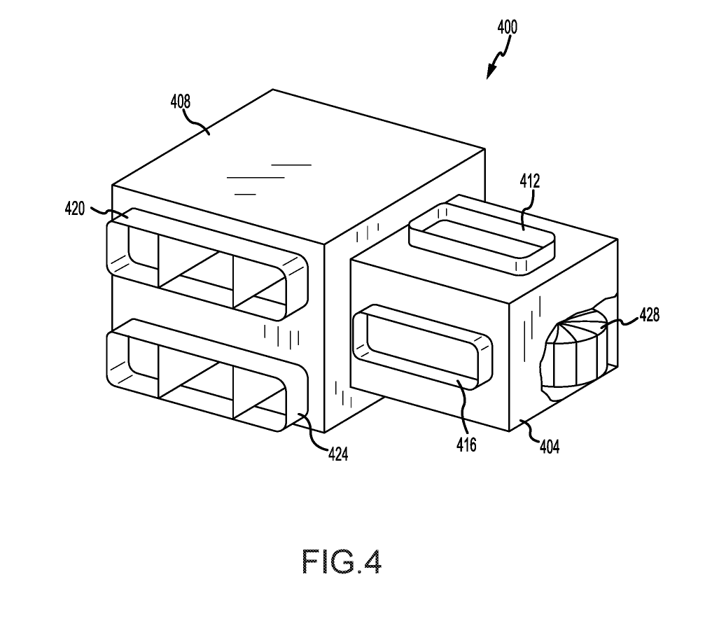

Referring now to FIG. 4, an HVAC module 400 according to embodiments of the present disclosure comprises two primary sections: an intake and blower section 404, and a conditioning and distribution section 408. The intake and blower section 404 comprises a fresh air intake 412 adapted to receive fresh air from outside the vehicle 100. The fresh air may be received, for example, via a cowl or plenum positioned on an exterior surface of the vehicle, and may be routed to the fresh air intake 412 via an air duct. The intake and blower section 404 further comprises a recirculation air intake 416. The recirculation air intake 416 is adapted to receive air from the passenger cabin 200. One or more doors or valves (not shown) may be provided at or near the fresh air intake 412 and the recirculation air intake 416 for selectively opening and closing the fresh air intake 412 and the recirculation air intake 416, respectively. By opening or closing these doors or valves, airflow through the fresh air intake 412 and the recirculation air intake 416 may be controlled. Thus, when an operator of the vehicle 100 selects fresh air (which may, in some embodiments, simply be the default intake option, such that the fresh air intake 412 is used unless the vehicle operator selects the recirculation option), the fresh air intake 412 opens and the recirculation air intake 416 closes. Alternatively, when an operator of the vehicle 100 selects recirculated air, the doors or valves of the recirculation air intake may open, and the doors or valves of the fresh air intake 412 may close. In this manner, air is received at the intake and blower section 404 from the passenger cabin 200, rather than from outside the vehicle 100. In still other embodiments, the doors or valves of the fresh air intake 412 and the recirculation air intake 416 may partially open or close so as to receive into the intake and blower section 404 a mixture of fresh and recirculated air. The extent to which the doors and valves partially open or close may be carefully controlled to achieve a specific proportion of fresh and recirculated air (which specific proportion may depend upon the temperature of the fresh and recirculated air, settings controlled by an operator of the vehicle, and/or other factors), or not. In some embodiments, the doors or valves of the fresh air intake 412 and of the recirculation air intake 416 may both be fully opened at the same time.

The intake and blower section 404 also comprises a blower 428 (visible through a cutaway portion of the sidewall of the intake and blower section 404), which sucks air into the intake and blower section 404 through one or both of the fresh air intake 412 and the recirculation air intake 416. The blower 428 may be driven by an electric motor, which may be configured to selectively operate at different speeds depending on the climate control inputs provided by a vehicle operator (or an automatic climate control software or algorithm). For example, if the vehicle operator (or an automatic climate control software or algorithm) sets the climate control system to make a large temperature change in the passenger cabin 200, the electric motor of the blower 428 may operate at a high speed, so as to take in as much air as possible. On the other hand, if the vehicle operator (or an automatic climate control software or algorithm) sets the climate control system to make a low temperature change in the passenger cabin 200, or simply to maintain an existing temperature in the passenger cabin 200, the electric motor of the blower 428 may operate at a low speed, thus reducing power consumption. The intake and blower section 404 may also comprise an air filter or other air monitoring/filtering device for detecting and/or filtering impurities in air received via the fresh air intake 412 and/or the recirculation air intake 416.

In some embodiments, the fresh air intake may be configured such that the forward speed of the vehicle may push air into the fresh air intake 412 (when the doors or valves of the fresh air intake 412 are open) when the vehicle 100 is traveling at a speed above some minimum threshold. In such embodiments, the blower 428 of the intake and blower section 404 may be configured to operate only when the recirculation air intake 416 is being used, or when the fresh air intake 412 is being used and the speed of the vehicle 100 is below the minimum threshold.

Beyond drawing air into the intake and blower section 404 via the fresh air intake 412 and/or the recirculation air intake 416, the blower 428 (or another fan provided in the HVAC module 400) may push received air into the conditioning and distribution section 408. In the conditioning and distribution section 408, the air received from the intake and blower section 404 is first heated or cooled (if necessary) in any manner known in the art. One or more temperature sensors may be provided in the conditioning and distribution section 408 for use in detecting an existing temperature of the air, which may then be used to determine whether and by how much the received air needs to be heated or cooled to reach the temperature desired by the operator (or an automatic climate control software or algorithm) of the vehicle 100. One or more temperature sensors may also be provided in the air ducts used to channel air from the HVAC module 400 to the passenger cabin 200 of the vehicle 100, and more particularly may be provided near the end of the air ducts, close to where the air exits the air ducts (and thus, in at least some embodiments, close to the occupants of the vehicle 100). Temperature sensors placed near the exit point of the air from the air ducts can measure the temperature of the air as it exits into the cabin 200, which information can be used to adjust the conditioning of the air by the HVAC module 400.

Once the received air has been properly conditioned (if conditioning is necessary), the conditioning and distribution section 408 routes the air to the appropriate supply air duct(s) for distribution to the passenger compartment or cabin 200. For this purpose, the conditioning and distribution section 408 comprises a first multi-channel outlet 420 for supplying air to the defrost vents 212a and/or the dash-level vents 212b, and a second multi-channel outlet 424 for supplying air to the foot vents 212c. Each multi-channel outlet 420 and 424 comprises a plurality of channels through which air may be routed, by the selective opening or closing of channel-specific doors or valves. Thus, for example, if an operator (or an automatic climate control software or algorithm) of the vehicle 100 selects the defrost function, one or more doors or valves associated with the channel(s) of the first multi-channel outlet 420 that supply air to the air vents 212b may close, while one or more doors or valves associated with the channel(s) of the first multi-channel outlet 420 that supply air to the air vent(s) 212a may open. As another example, if an operator (or an automatic climate control software or algorithm) of the vehicle 100 selects the dash-level and foot-level air vents 212b and 212c, respectively, for supplying air to the passenger cabin 200, then the doors or valves associated with channel(s) of the first multi-channel outlet 420 that supply air to the defrost air vent(s) 212a may close, while the doors or valves associated with the channels of the first and second multi-channel outlets 420 and 424 that supply air to the dash-level and foot-level air vents 212b and 212c may open. In this manner, the flow of air to the various air vents 212 in the passenger cabin 200 may be selectively controlled.

Although depicted with two multi-channel outlets 420 and 424, the HVAC module 400 may comprise a single multi-channel outlet with air channels for all vents, or more than two multi-channel outlets, each with air channels for fewer than all vents. In some embodiments, the HVAC module 400 may comprise one or more multi-channel outlets such as the outlets 420 and 424, and one or more single-channel outlets.

In some embodiments, the first and second multi-channel outlets 420 and 424 may have a total cross-sectional area of greater than five hundred and fifty (550) square centimeters. Also in some embodiments, the fresh air intake 412 and the recirculation air intake 416 may have a total cross-sectional area of greater than four hundred and thirty (430) square centimeters.

Although the intake and blower section 404 and the conditioning and distribution section 408 of the HVAC module 400 are shown as boxes, persons of ordinary skill in the art will realize, based on the present disclosure, that the outer shape of the HVAC module 400 (and any other HVAC module according to embodiments of the present disclosure) is not limited to any particular shape.

Additionally, while the first and second multi-channel outlets 420 and 424 are depicted as located on the side of the conditioning and distribution section 408 that is to be mounted adjacent a rear wall 320 (e.g., on a rear-facing side of the conditioning and distribution section 408), one or both of the first and second multi-channel outlets 420 and 424, and/or one or more additional outlets (whether multi-channel or not) may be positioned on a top, bottom, or different side of the conditioning and distribution section 408. For example, an outlet for supplying air to foot-level air vents 212c via an appropriate duct (as shown, for example, in FIG. 3) may be positioned on the bottom surface of the conditioning and distribution section 408. Placement of an outlet on the surface that faces the direction the supplied air needs to travel to reach its intended destination (e.g., air vents 212a, 212b, or 212c) reduces the complexity of the needed ducting and the amount of the needed ducting, while also improving the efficiency with which conditioned air may be supplied to the passenger cabin 200 by reducing the number of directional changes that the air must make as it travels from the conditioning and distribution section 408 to the passenger cabin 200.

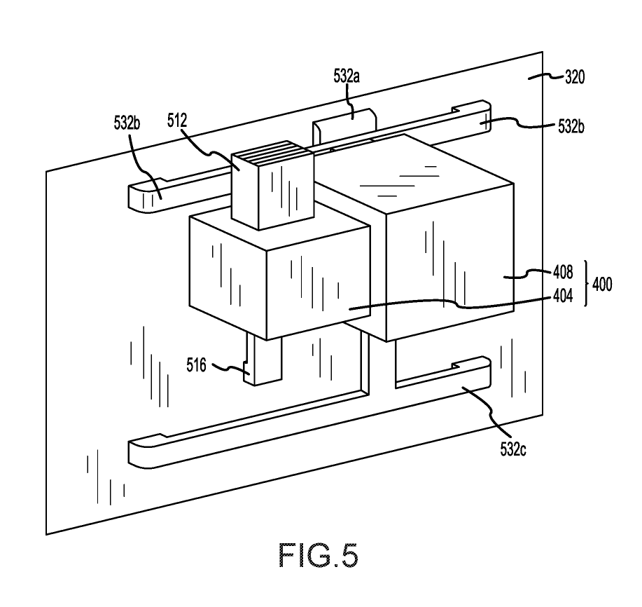

With reference now to FIG. 5, an HVAC module 400 may be mounted to, or mounted adjacent to, a dash wall 320, such that the HVAC module 400 is located within the front compartment 304 of a vehicle 100, thus freeing up space within the passenger cabin 200. In FIG. 5, the various components of the vehicle surrounding the dash wall 320 are not shown. The intake and blower section 404 of the HVAC module 400 comprises a fresh air intake duct 512 configured to receive air from outside of the vehicle 100. For example, the fresh air intake 512 may extend from a fresh air intake such as the fresh air intake 412 upward to a cowling or other opening in the hood 116, through which fresh air may be received. The intake and blower section 404 may further comprise recirculation air intake ducts 516a and 516b, for receiving air from the passenger cabin 200 and routing them to a recirculation air intake such as the recirculation air intake 416.

The conditioning and distribution section 408 comprises several ducts extending from its multi-channel outlets (described above in connection with FIG. 4). The duct 532a provides air to one or more defrost air vents such as the air vents 212a. The ducts 532b provide air to one or more dash-level air vents, such as the air vents 212b. The duct 532c provides air to one or more foot-level air vents, such as the air vents 212c. Although the HVAC module 400 is depicted in FIG. 5 with one duct configuration, many other duct configurations are possible, and persons of ordinary skill in the art will know how to route air to the desired vents within the passenger cabin 200 from the HVAC module 400 in the front compartment 304 of the vehicle 100 based on the present disclosure. For example, although the ducts 532b and 532c are shown forward of the wall 320 in FIG. 5, in some embodiments the ducts 532b and 532c may be primarily rearward of the wall 320. The present disclosure encompasses any arrangement of the ducts 532 that channels air from the HVAC module 400 to one or more air vents in the passenger cabin 200.

The duct 516, as depicted in FIG. 5, is in fluid communication with a register in the passenger cabin 200 and with the recirculation air intake 416. The duct 516 is thus used to receive air from the register in the passenger cabin for recirculation. One or more doors or valves may be provided within the recirculation air intake 416 or within the duct 516 to selectively control the flow of air through the duct 516 and into the recirculation air intake 416.

The features of the various embodiments described herein are not intended to be mutually exclusive. Instead, features and aspects of one embodiment may be combined with features or aspects of another embodiment. Additionally, the description of a particular element with respect to one embodiment may apply to the use of that particular element in another embodiment, regardless of whether the description is repeated in connection with the use of the particular element in the other embodiment.

Examples provided herein are intended to be illustrative and non-limiting. Thus, any example or set of examples provided to illustrate one or more aspects of the present disclosure should not be considered to comprise the entire set of possible embodiments of the aspect in question. Examples may be identified by the use of such language as “for example,” “such as,” “by way of example,” “e.g.,” and other language commonly understood to indicate that what follows is an example.

The systems and methods of this disclosure have been described in relation to the installation of an HVAC module in a vehicle. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Embodiments include a vehicle, comprising: a passenger compartment; a front compartment forward of the passenger compartment; a wall separating the passenger compartment from the front compartment; and an HVAC module mounted on the wall in the front compartment, the HVAC module comprising an intake and blower section and a conditioning and distribution section.

Aspects of the above vehicle include: the intake and blower section comprises a fresh air intake; the intake and blower section comprises a recirculation air intake; the conditioning and distribution section comprises at least one multi-channel outlet; the at least one multi-channel outlet comprises a plurality of channels configured to be selectively opened or closed; the at least one multi-channel outlet is in fluid communication with a plurality of air vents via a plurality of ducts; a first one of the plurality of air vents is a defrost air vent and a second one of the plurality of air vents is a positioned near a floor of the passenger cabin; the at least one multi-channel outlet faces the wall; and the intake and blower section is configured to receive air via at least one of the fresh air intake and the recirculation air intake, and to provide the received air to the conditioning and distribution section.

Embodiments also include an HVAC module comprising: a first section comprising a fresh air intake, a recirculation air intake, and a blower; and a second section comprising a system for conditioning air, a first multi-channel outlet, and a second multi-channel outlet, the second section configured to receive air from the first section, condition the air with the system for conditioning air, and distribute the conditioned air via at least one of the first multi-channel outlet and the second multi-channel outlet, wherein the HVAC module is mounted on a rear wall of a front compartment of a vehicle, the front compartment positioned forward of a passenger cabin of the vehicle and separated from the passenger cabin by the rear wall.

Aspects of the above HVAC module include: the fresh air intake is configured to receive air from outside the vehicle; the recirculation air intake is in selective fluid communication with the passenger cabin of the vehicle; the system for conditioning air is equipped to selectively heat or cool air received from the first section; the HVAC module is mounted on the rear wall such that the first and second multi-channel outlets face the rear wall; each of the first and second multi-channel outlets is connected to a plurality of ducts, and each of the plurality of ducts is in fluid communication with the passenger cabin of the vehicle; the blower is configured to selectively operate at a plurality of speeds; and the second section comprises at least one temperature sensor.

Embodiments further include an electric vehicle comprising: a passenger cabin; a front compartment located forward of the passenger cabin and separated from the passenger cabin by a wall; an HVAC module mounted in the front compartment proximate the wall, the HVAC module comprising a receiving section configured to receive air and a distributing section configured to distribute the received air; and a plurality of ducts extending from the distributing section to a plurality of vents, the plurality of ducts establishing fluid communication between the distributing section and the passenger cabin.

Aspects of the above electric vehicle include: the receiving section is configured to receive air through at least one of a fresh air intake and a recirculation air intake; and the distributing section is configured to receive air from the receiving section, change the temperature of the air with one of heating equipment and cooling equipment, and selectively discharge the air through fewer than all of the plurality of ducts. Any one or more of the aspects/embodiments as substantially disclosed herein.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

1. A vehicle, comprising:
a passenger compartment;
a front compartment forward of the passenger compartment;
a wall separating the passenger compartment from the front compartment;
an HVAC module mounted on the wall in the front compartment, the HVAC module comprising an intake and blower section and a conditioning and distribution sections; and
a duct extending through the front compartment along the wall to an air vent in the wall, the duct in fluid communication with the conditioning and distribution section.

2. The vehicle of claim 1, wherein the intake and blower section comprises a fresh air intake.

3. The vehicle of claim 1, wherein the intake and blower section comprises a recirculation air intake.

4. The vehicle of claim 1, wherein the conditioning and distribution section comprises at least one multi-channel outlet.

5. The vehicle of claim 4, wherein the at least one multi-channel outlet comprises a plurality of channels configured to be selectively opened or closed.

6. The vehicle of claim 4, wherein the at least one multi-channel outlet is in fluid communication with a plurality of air vents via a plurality of ducts.

7. The vehicle of claim 6, wherein a first one of the plurality of air vents is a defrost air vent and a second one of the plurality of air vents is positioned near a floor of the passenger compartment.

8. The vehicle of claim 4, wherein the at least one multi-channel outlet faces the wall.

9. The vehicle of claim 1, wherein the intake and blower section is configured to receive air via at least one of a fresh air intake and a recirculation air intake, and to provide the received air to the conditioning and distribution section.

10. An HVAC module comprising:
a first section comprising a fresh air intake, a recirculation air intake, and a blower; and
a second section comprising a heating device for heating air, a cooling device for cooling air, a first multi-channel outlet, and a second multi-channel outlet, the second section configured to receive air from the first section, condition the air with the heating device or the cooling device, and distribute the conditioned air via at least one of the first multi-channel outlet and the second multi-channel outlet,
wherein the HVAC module is mounted on a rear wall of a front compartment of a vehicle, the front compartment positioned forward of a passenger cabin of the vehicle and separated from the passenger cabin by the rear wall; and
wherein each channel of the first multi-channel outlet may be selectively closed.

11. The HVAC module of claim 10, wherein the fresh air intake is configured to receive air from outside the vehicle.

12. The HVAC module of claim 10, wherein the recirculation air intake is in selective fluid communication with the passenger cabin of the vehicle.

13. The HVAC module of claim 10, wherein the heating device and the cooling device are a single device equipped to selectively heat or cool air received from the first section.

14. The HVAC module of claim 10, wherein the HVAC module is mounted on the rear wall such that the first and second multi-channel outlets face the rear wall.

15. The HVAC module of claim 10, wherein each of the first and second multi-channel outlets is connected to a plurality of ducts, and each of the plurality of ducts is in fluid communication with the passenger cabin of the vehicle.

16. The HVAC module of claim 10, wherein the blower is configured to selectively operate at a plurality of speeds.

17. The HVAC module of claim 10, wherein the second section comprises at least one temperature sensor.

18. An electric vehicle comprising:
a passenger cabin;
a front compartment located forward of the passenger cabin and separated from the passenger cabin by a wall;
an HVAC module mounted in the front compartment proximate the wall, the HVAC module comprising:
an intake and blower section configured to receive air; and
a conditioning and distribution section configured to distribute the received air; and
a plurality of ducts extending from the distributing section to a plurality of vents, the plurality of ducts establishing fluid communication between the distributing section and the passenger cabin,
wherein at least one of the plurality of ducts extends through the front component along the wall.

19. The electric vehicle of claim 18, wherein the intake and blower section is configured to receive air through at least one of a fresh air intake and a recirculation air intake.

20. The electric vehicle of claim 18, wherein the conditioning and distribution section is configured to receive air from the intake and blower section, change the temperature of the air with a heating device or a cooling device, and selectively discharge the air through fewer than all of the plurality of ducts.
